(19) United States
(12) Patent Application Publication
(10) Pub. No.: US 2025/0071247 A1
(43) Pub. Date: Feb. 27, 2025

(54) DISPLAY DEVICE CAPABLE OF REDUCING INFLUENCE OF TROUBLE IN SYSTEM, INFORMATION PROCESSING APPARATUS, METHODS OF CONTROLLING THESE, AND INFORMATION PROCESSING SYSTEM

(71) Applicant: CANON KABUSHIKI KAISHA, Tokyo (JP)

(72) Inventor: Akihito TAKETANI, Tokyo (JP)

(21) Appl. No.: 18/804,239

(22) Filed: Aug. 14, 2024

(30) Foreign Application Priority Data
Aug. 22, 2023 (JP) 2023-134707

(51) Int. Cl. H04N 13/194; H04N 13/156; H04N 13/167; H04N 13/178; H04N 13/398

(52) U.S. Cl. CPC H04N 13/194; H04N 13/156; H04N 13/167; H04N 13/178; H04N 13/398

(57) ABSTRACT

A display device including a control communication section configured to perform communication with an external apparatus, and a display section configured to display an image. Image data of an image to be displayed on the display unit is acquired from the external apparatus via a network. A video correction section corrects an image to be displayed on the display unit. Metadata of information concerning an operating state and a communication state of the display device is generated and transmitted to the external apparatus in a state attached to data to be transmitted to the external apparatus.

### BACKGROUND OF THE INVENTION

### Field of the Invention

The present invention relates to an information processing system formed by communicably connecting a display device and an information processing apparatus, which is capable of reducing the influence of a trouble in the system.

### Description of the Related Art

As a technique for reproducing a virtual space, virtual reality (VR) is known. Further, as a technique for seamlessly integrating a real space and a virtual space on a real-time basis, the mixed reality (MR) technique and the augmented reality (AR) technique are known. These techniques are executed e.g. by using a head mount display (HMD). That is, a user (wearer) of the HMD can view and appreciate a computer graphics (CG) video according to a position and a posture of the HMD regardless of whether or not the CG video is superimposed on a field of vision of the real space. In viewing the CG video, although there is a case where all processing operations associated with generation and display of the CG video are performed within the HMD, in recent years, a use form has increased in which the HMD is connected to a network and part of the processing operations is performed by an information processing apparatus (rendering apparatus) connected to the network.

For example, Japanese Laid-Open Patent Publication (Kokai) No. 2019-28368 discloses a system that displays an image transmitted from the rendering apparatus on an HMD. In the system described in Japanese Laid-Open Patent Publication (Kokai) No. 2019-28368, the HMD detects a posture thereof and receives frame data of an image to be displayed on the HMD and predicted posture information of the HMD, which is synchronized with the frame data, from the rendering apparatus. Then, the HMD corrects the frame data of the image such that the frame data suits the latest posture so as to cause the frame data to suit the latest posture, based on a difference between the latest posture information detected by itself and the received predicted posture information. Further, PCT International Patent Publication No. 2020/116154 discloses an information processing apparatus that causes, when distributing contents (video) on which a user can freely set a visual line direction and a viewpoint position for reproduction of the contents, information enabling selection of a bit rate of reproduction of the contents to be includes in metadata.

According to the above-described technique disclosed in Japanese Laid-Open Patent Publication (Kokai) No. 2019-28368, it is possible to suppress occurrence of so-called simulator sickness, and according to the technique disclosed in PCT International Patent Publication No. 2020/116154, it is possible to improve the robustness of contents reproduction. However, in the above-described Japanese Laid-Open Patent Publication (Kokai) No. 2019-28368 and PCT International Patent Publication No. 2020/116154, when delay of processing, caused by the increased calculation load, freeze of a processor in the device, a trouble in a signal transmission path, or the like trouble occurs in the system, reduction of the influence of such trouble is not studied.

### SUMMARY OF THE INVENTION

The present invention provides a technique for reducing the influence of a trouble occurring in a system including a display device and an information processing apparatus communicably connected to each other.

In a first aspect of the present invention, there is provided a display device including a communication unit configured to perform communication with an external apparatus, a display unit configured to display an image, at least one processor, and a memory coupled to the at least one processor storing instructions that, when executed by the processor, cause the processor to function as: an acquisition unit configured to acquire image data of an image to be displayed on the display unit, from the external apparatus via the communication unit, a correction unit configured to correct the image to be displayed on the display unit, and a control unit configured to generate first metadata of information concerning an operating state and a communication state of the display device and attach the generated first metadata to data to be transmitted to the external apparatus.

In a second aspect of the present invention, there is provided an information processing apparatus that performs communication with a display device, including at least one processor, and a memory coupled to the at least one processor storing instructions that, when executed by the processor, cause the processor to function as: a reception unit configured to receive information for estimating a position and/or a posture of the display device, an estimation unit configured to estimate the position and/or the posture of the display device based on the information, a generation unit configured to generate an image to be displayed on a display unit included in the display device, based on the position and/or the posture of the display device, which are/is estimated by the estimation unit, a transmission unit configured to transmit image data of an image generated by the generation unit to the display device, and a control unit configured to generate metadata of information concerning an operating state and a communication state of the information processing apparatus and attach the generated metadata to data to be transmitted to the display device.

In a third aspect of the present invention, there is provided an information processing system including a display device and an information processing apparatus, wherein the display device includes a first communication unit configured to perform communication with the information processing apparatus, a display unit configured to display an image, at least one processor; and a memory coupled to the at least one processor storing instructions that, when executed by the processor, cause the processor to function as: a detection unit configured to detect information for estimating a position and/or a posture of the display device, an acquisition unit configured to acquire an image to be displayed on the display unit from the information processing apparatus, a first correction unit configured to correct the image to be displayed on the display unit, and a first control unit configured to generate first metadata of information concerning an operating state and a communication state of the display device and attach the generated first metadata to data to be transmitted to the information processing apparatus, and wherein the information processing apparatus includes a second communication unit configured to perform communication with the display device, at least one processor, and a memory coupled to the at least one processor storing instructions that, when executed by the processor, cause the processor to function as: a first estimation unit configured to estimate a position and/or a posture of the display device based on the information acquired from the display device via the second communication unit, a first generation unit configured to generate an image to be displayed on the display unit based on the position and/or the posture of the display device, estimated by the first estimation unit, a transmission unit configured to transmit an image generated by the first generation unit to the display device, and a second control unit configured to generate second metadata of information concerning an operating state and a communication state of the information processing apparatus and attach the generated second metadata to data to be transmitted to the display device.

According to the present invention, in the system in which the display device and the information processing apparatus are communicably connected, it is possible to reduce the influence of a trouble having occurred in the system.

Further features of the present invention will become apparent from the following description of exemplary embodiments (with reference to the attached drawings).

### BRIEF DESCRIPTION OF THE DRAWINGS

FIG. 1 is a diagram showing a schematic configuration of a display communication system according to a first embodiment.

FIG. 2 is a diagram showing a schematic configuration of a display communication system according to a second embodiment.

FIG. 3 is a diagram showing a schematic configuration of a display communication system according to a third embodiment.

FIG. 4 is a diagram showing a schematic configuration of a display communication system according to a fourth embodiment.

### DESCRIPTION OF THE EMBODIMENTS

The present invention will now be described in detail below with reference to the accompanying drawings showing embodiments thereof. In the following embodiments, a description will be given of an information processing system in which a display device that displays a virtual video before eyes of a user and an information processing apparatus that generates the virtual video to be displayed on the display device are communicably connected to each other. As an example of the display device, an HMD will be described, and the information processing apparatus is referred to as the “virtual video generation apparatus”. The virtual video generation apparatus is a server (computer) or the like.

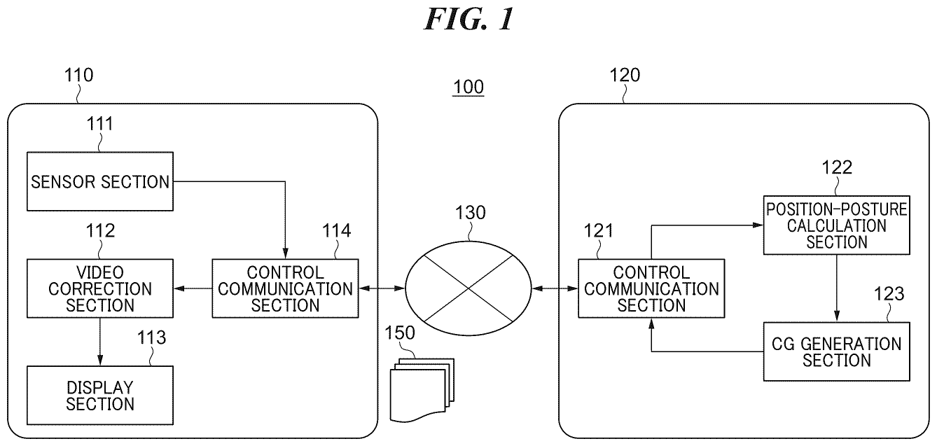

FIG. 1 is a diagram showing a schematic configuration of a display communication system 100 according to a first embodiment. The display communication system 100 is formed by communicably connecting the HMD, denoted by reference numeral 110, and the virtual video generation apparatus, denoted by reference numeral 120, via a network 130.

The HMD 110 includes a sensor section 111, a video correction section 112, a display section 113, and a control communication section 114. The virtual video generation apparatus 120 includes a control communication section 121, a position-posture calculation section 122, and a CG generation section 123.

A user of the HMD 110 can view a virtual video or the like displayed on the display section 113 by wearing the HMD 110 on his/her head. All of the component elements of the HMD 110 are not necessarily required to be worn on the user's head, but for example, part of the component elements of the HMD 110 can be worn on a body part of the user, such as his/her shoulder or waist, or placed on a desk, the floor, or the like. This form of the HMD 110 is similarly applied to the HMDs in second to fourth embodiments, described hereinafter.

The sensor section 111 detects information (physical amount) for estimating a position and/or a posture of the HMD 110 and outputs a signal corresponding to the detected physical amount (hereinafter referred to as the “sensor signal”). Although the sensor section 111 is often formed by an acceleration sensor and an angular speed sensor, this is not limitative, but the sensor section 111 can include a geomagnetic sensor, an atmospheric pressure sensor, and an image sensor for acquiring a video of the outside. For example, the control communication section 114 of the HMD 110 and the position-posture calculation section 122 of the virtual video generation apparatus 120 can estimate the position and posture of a user by identifying a predetermined object and feature points and performing calculation and collation based on video information output from the image sensor. The sensor section 111 can include a sensor for acquiring depth information based on a time period required by an emitted light to be reflected by an object surface and return, such as a Time of Flight (TOF) sensor and a light detection-and-ranging (LiDAR) sensor, and it is also possible to estimate the position and posture of the HMD 110 based on the acquired depth information.

In a case where the sensor signal output from the sensor section 111 is an analog electrical signal, the control communication section 114 generates a digital signal (hereinafter referred to as the “sensor data”) by converting the analog electrical signal from analog to digital. The sensor section 111 can be configured to perform analog-to-digital conversion by itself and output the sensor data. The control communication section 114 transmits the sensor data to the virtual video generation apparatus 120 in a predetermined file format via the network 130. In a case where the sensor section 111 is formed by a plurality of sensors, the sensor data related to the sensor signals output from all of the sensors is transmitted to the virtual video generation apparatus 120.

The video correction section 112 corrects and processes a video to be displayed on the display section 113. For example, the video correction section 112 performs processing for correcting a resolution and colors of the video and adding information, such as characters, to part of the video, or the like processing. Further, in a case where delay is caused in a virtual video transmitted from the virtual video generation apparatus 120, the video correction section 112 shifts and deforms the video according to a command from the control communication section 114. With this, it is possible to make the user feel as if the delay of the video is reduced and thereby reduce uncomfortable feeling felt by the user with respect to the video.

The display section 113 is often formed by combining a liquid-crystal display (LCD), a liquid crystal on silicon (LCOS), an organic light-emitting diode (OLED), or the like, and an eyepiece optical system, and displays a virtual video acquired from the virtual video generation apparatus 120 within a range of a visual field of a user regardless of or according to a posture of the user. At this time, if the display section 113 is made translucent, the user can view a real video of the outside at the same time, and therefore, expression close to expression of AR can be realized. On the other hand, if the display section 113 is a light shading type, expression of VR which enables the user to view only the virtual video is realized.

The control communication section 114 is a semiconductor integrated circuit comprised of a central processing unit (CPU), a read only memory (ROM) storing programs executed by the CPU, and a random access memory (RAM) having a program loading area and an area for temporarily storing data. The control communication section 114 performs centralized control of the operations of the components of the HMD 110 by loading the programs stored in the ROM into the RAM to thereby control the overall operation of the HMD 110. Further, the control communication section 114 performs communication with the control communication section 121 of the virtual video generation apparatus 120 according to a predetermined protocol. Further, the control communication section 114 can analyze sensor signals acquired by the sensor section 111 and instruct, based on a result of the analysis, the video correction section 112 to perform predetermined image processing on the virtual video acquired from the virtual video generation apparatus 120. Further, the control communication section 114 can analyze metadata attached to a variety of data items acquired from the virtual video generation apparatus 120 and instruct, based on a result of the analysis, the video correction section 112 to perform predetermined image processing on the virtual video acquired from the virtual video generation apparatus 120.

The network 130 communicably connects between the HMD 110 and the virtual video generation apparatus 120, and further communicably connects the HMD 110 and the virtual video generation apparatus 120 to an external apparatus, not shown. At this time, the HMD 110 is often referred to as the client-side, device-side, or edge-side apparatus, and on the other hand, the virtual video generation apparatus 120 is often referred to as the server-side or cloud-side apparatus. The display communication system 100 can be configured as the peer-to-peer system in which the HMD 110 and the virtual video generation apparatus 120 are directly connected without using the network 130.

The virtual video generation apparatus 120 generates a virtual video to be viewed by a user using the HMD 110 and transmits the generated virtual video to the HMD 110 via the network 130. The virtual video generation apparatus 120 can function by causing the components, existing at separate locations, to perform processing in cooperation, via the network 130 or another communication means. This form is similarly applied to the virtual video generation apparatuses in the second to fourth embodiments, described hereinafter.

In the virtual video generation apparatus 120, the control communication section 121 is a semiconductor integrated circuit comprised of a CPU, a ROM storing programs executed by the CPU, and a RAM having a program loading area and an area for temporarily storing data. The control communication section 121 performs centralized control of the operations of the components of the virtual video generation apparatus 120, by loading the programs stored in the ROM into the RAM to thereby control the overall operation of the virtual video generation apparatus 120. Further, the control communication section 121 performs communication with the control communication section 114 of the HMD 110 according to a predetermined protocol.

The sensor data is transmitted from the control communication section 114 of the HMD 110 to the control communication section 121 of the virtual video generation apparatus 120. The control communication section 121 transfers the sensor data to the position-posture calculation section 122, and the position-posture calculation section 122 performs calculation for estimating a position and/or a posture of the HMD 110 by using the sensor data. At this time, the position-posture calculation section 122 performs the calculation on all of the sensor data transmitted from the HMD 110. For example, if the sensor section 111 of the HMD 110 includes an inertial sensor (such as an acceleration sensor and an angular speed sensor), the position-posture calculation section 122 performs the calculation on sensor data associated with a signal output from the inertial sensor. Similarly, if the sensor section 111 of the HMD 110 includes an image sensor (such as a CMOS sensor), the position-posture calculation section 122 performs the calculation on image data which is a signal output from the image sensor. Note that the calculation for estimating a position and/or a posture of the HMD 110 is referred to as Simultaneous Localization And Mapping (SLAM).

The CG generation section 123 generates a virtual video to be displayed on the display section 113 of the HMD 110 by using CG. Hereinafter, the virtual video generated by the CG generation section 123 is referred to as the “CG video”, and expression “a CG video is displayed on the display section 113 of the HMD 110” is used. For example, the CG generation section 123 generates a CG video to be displayed in a direction in which the user is viewing, based on a result of estimation performed by calculation of the position-posture calculation section 122. Note that the processing performed by the CG generation section 123 for generating a CG video is referred to as “rendering”. Further, in the present embodiment, the CG generation section 123 performs rendering based on an estimation result performed by calculation of the position-posture calculation section 122, in principle. However, this is not limitative, but the CG generation section 123 can generate a video which is not relayed to the position and posture of the HMD 110.

The control communication section 114 of the HMD 110 and the control communication section 121 of the virtual video generation apparatus 120 each attach metadata 150 to a variety of data items, in other words, generate a data file formed by attaching the metadata to transmission data, to perform transmission and reception of the data file. For example, the HMD 110 transmits the sensor data to the virtual video generation apparatus 120 via the network 130 and receives video data of a CG video to be displayed on the display section 113 from the virtual video generation apparatus 120 via the network 130. Further, the HMD 110 and the virtual video generation apparatus 120 transmit and receive control data for maintaining communication with each other. The metadata 150 included in the data file transmitted and received at this time includes information concerning an operating state and a communication state of the apparatus (such as information indicating a steady (normal) state, information indicating that a predetermined processing section is in a start-up state, interrupted state, or a temporarily incapable state, or the like). The control communication sections 114 and 121 each can grasp the communication state of the network 130 based on the control data for maintaining communication, and causes the information concerning the communication state of the network 130 to be included in the metadata 150.

In the following description, transmitting and receiving a data file to which the metadata is attached are simply expressed e.g. as “receiving metadata” and “transmitting metadata”, respectively.

Next, a variety of processing operations executed in the display communication system 100 and a flow of a variety of data items will be described.

As described above, the variety of sensors as the components of the sensor section 111 of the HMD 110 perform measurement (sensing) of a physical amount according to the respective functions of the variety of sensors, and the sensor signals output from the variety of sensors which perform the sensing are converted to sensor data. The control communication section 114 attaches the metadata as the information concerning the operating state and the communication state of the HMD 110 to the sensor data, and transmits the sensor data to the virtual video generation apparatus 120 via the network 130.

Upon receipt of the sensor data, the control communication section 121 of the virtual video generation apparatus 120 transfers the received sensor data to the position-posture calculation section 122. Further, the control communication section 121 analyzes the information of the metadata attached to the sensor data. The position-posture calculation section 122 performs calculation for estimating a position and/or a posture of the HMD 110 based on the acquired sensor data and outputs the obtained calculation result to the CG generation section 123. The CG generation section 123 generates a CG video to be displayed on the display section 113 of the HMD 110, based on the acquired calculation result. The control communication section 121 transmits the CG video data generated by the CG generation section 123 to the HMD 110 via the network 130. At this time, the control communication section 121 attaches metadata as information concerning the operating state and the communication state of the virtual video generation apparatus 120 to a variety of data items to be transmitted to the HMD 110.

Upon receipt of the CG video data from the control communication section 121 of the virtual video generation apparatus 120, the control communication section 114 of the HMD 110 transfers the received CG video data to the video correction section 112. The video correction section 112 corrects the acquired CG video data as required, converts the CG video data to display signals, and transmits the display signals to the display section 113. With this, the CG video is displayed on the display section 113 and the user of the HMD 110 can view the CG video.

As described above, since various processing operations are performed within the HMD 110 and the virtual video generation apparatus 120 and the data is transmitted and received via the communication path, it is assumed that delay is more or less caused in the display of the CG video on the display section 113 with respect to motion of the user of the HMD 110. However, in a state in which the display communication system 100 is stably operating, the delay amount is also stable. Therefore, the video correction section 112 shifts or deforms the CG video based on the sensor data according to an instruction from the control communication section 114, whereby it is possible to cancel out the motion of the user. Thus, it is possible to present the CG video to the user as if the delay of display is not caused or reduced. This processing is generally referred to as the “reprojection processing”, and is a technique widely used in the display of the CG video on the HMD. However, if the shift amount is increased, this sometimes leads to reduction of the angle of view or occurrence of simulator sickness, and hence an upper limit is often set to the shift amount.

In the display communication system 100, for example, there are a case where the virtual video generation apparatus 120 is also part of another information processing system, and a case where the virtual video generation apparatus 120 performs calculation with respect to an external apparatus (not shown) connected to the network 130 in parallel. In such cases, in the virtual video generation apparatus 120, a situation can occur where resources applied to the calculation of the position and the posture of the HMD 110 are reduced due to the interrupting use of the calculation resources. As a result, there is a possibility that delay occurs in the position-posture calculation performed by the position-posture calculation section 122. Thus, in the display communication system 100, not only the above-described quantitative delay but also a trouble, such as unexpected delay, can occur.

To cope with the trouble, in the present embodiment, the control communication section 121 of the virtual video generation apparatus 120 generates metadata of delay information determined or estimated based on the operating state of the position-posture calculation section 122. Note that the control communication section 121 estimates an amount of delay in the processing in the position-posture calculation section 122, from an amount of all calculations to be executed and an executable amount of calculation, based on a variety of data items received from the HMD 110 and the external apparatus (not shown) connected to the network 130. Then, the control communication section 121 transmits the generated metadata to the HMD 110 in a state attached to the variety of data items, such as the CG video data and the data for performing communication control.

The control communication section 114 of the HMD 110, having received the metadata including the delay information, instructs the video correction section 112 to temporarily raise the upper limit of the reprojection processing. This makes it possible to continue the display of the CG video on the HMD 110 such that it is made difficult for the user of the HMD 110 to notice a delay occurring in the virtual video generation apparatus 120.

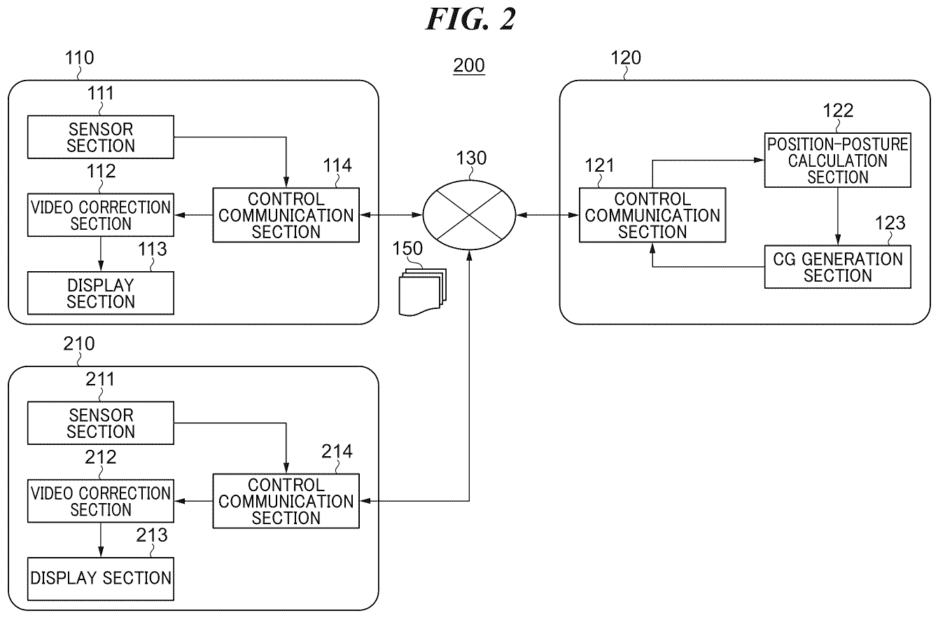

FIG. 2 is a diagram showing a schematic configuration of a display communication system 200 according to a second embodiment. The display communication system 200 is formed by communicably connecting the HMD 110 and an HMD 210 and the virtual video generation apparatus 120 via the network 130. The HMD 110, the network 130, the virtual video generation apparatus 120, and the metadata 150 are the same as those described in the first embodiment, and hence description thereof is omitted.

The HMD 210 is used by a person different from the user of the HMD 110. The HMD 210 includes a sensor section 211, a video correction section 212, a display section 213, and a control communication section 214, and these components are the same as those of the HMD 110. That is, the HMD 210 is substantially the same as the HMD 110 and hence detailed description thereof is omitted.

Note that in the present embodiment, as an example of the display communication system in which a plurality of HMDs are connected to the network, a configuration in which two HMDs are connected to the network is described. That is, the display communication system in the present embodiment can be configured by connecting three or more HMDs to the network. Similarly, the display communication system in the present embodiment can be formed by connecting a plurality of virtual video generation apparatuses to the network. Further, the virtual video generation apparatus connected to the network can includes a plurality of processing units each formed by the one virtual video generation apparatus 120 as one processing unit. Hereafter, the description will be given assuming the configuration shown in FIG. 2.

Similar to the first embodiment, the position-posture calculation section 122 of the virtual video generation apparatus 120 calculates a position and/or a posture of the HMD 110 and further calculates a position and/or a posture of the HMD 210. The CG generation section 123 generates a CG video to be displayed on the HMDs 110 and 210. That is, in the display communication system 200, the users of the HMDs 110 and 210 can view the same CG video and thereby experience VR, AR, or MR. Similar to the first embodiment, the control communication section 121 transmits the metadata 150 of delay information determined or estimated based on the operating states of the position-posture calculation section 122 and the CG generation section 123 to the HMDs 110 and 210.

For example, let it be assumed that the position-posture calculation for the HMD 110 is delayed e.g. due to occurrence of resources consumption for an external system (not shown), in the virtual video generation apparatus 120, or a trouble caused in communication between the apparatuses connected to the network 130. In this case, similar to the first embodiment, the control communication section 121 of the virtual video generation apparatus 120 transmits the metadata including the delay information indicating occurrence of delay of the position-posture calculation for the HMD 110, to the HMD 110. Further, the control communication section 121 transmits the same metadata to the HMD 210 for which the position-posture calculation is not delayed. Thus, the control communication section 114 of the HMD 110 and the control communication section 214 of the HMD 210 receive the metadata including the same delay information.

The control communication sections 114 and 214 instruct the video correction sections 112 and 212 to additionally display information to the effect that the position-posture calculation for the HMD 110 is delayed on the CG video displayed on the display sections 113 and 213, respectively. The video correction sections 112 and 212 perform correction so as to display the fact that the position-posture calculation for the HMD 110 is delayed, on the CG video, and output the corrected CG video to the display sections 113 and 213, respectively.

With this, the user of the HMD 210 can recognize that the position-posture calculation for the HMD 110 is delayed. Therefore, for example, in a case where an avatar of the user of the HMD 110 is displayed on the CG video, or in a case where the users of the HMDs 110 and 210 are performing voice communication using different means, the user of the HMD 210 can understand a situation of the user of the HMD 110.

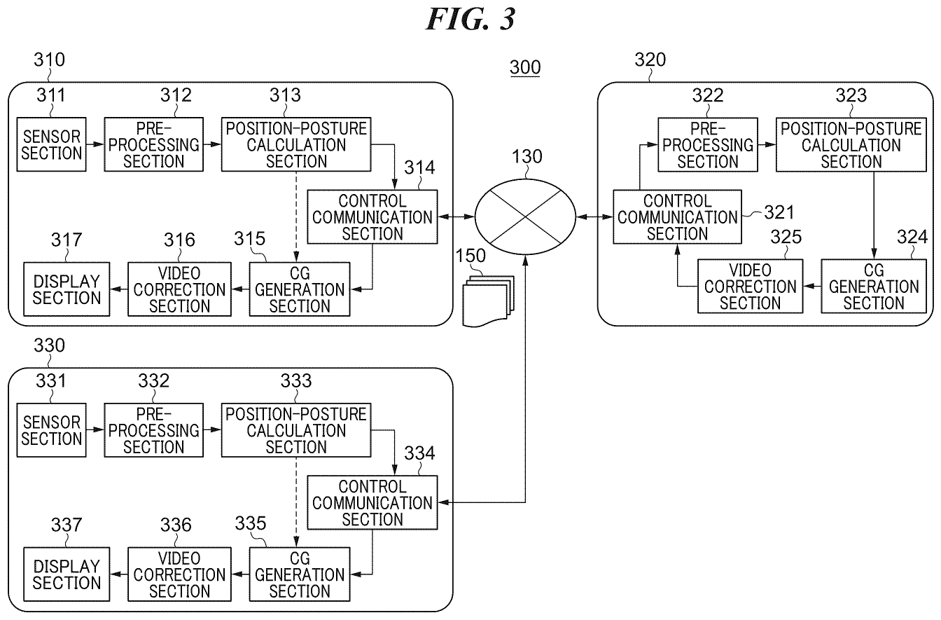

FIG. 3 is a diagram showing a schematic configuration of a display communication system 300 according to a third embodiment. The display communication system 300 is formed by communicably connecting HMDs 310 and 330 and a virtual video generation apparatus 320, via the network 130.

The HMD 310 includes a sensor section 311, a pre-processing section 312, a position-posture calculation section 313, a control communication section 314, a CG generation section 315, a video correction section 316, and a display section 317. Similar to the HMD 310, the HMD 330 includes a sensor section 331, a pre-processing section 332, a position-posture calculation section 333, a control communication section 334, a CG generation section 335, a video correction section 336, and a display section 337. Different from the HMDs 110 and 210 in the first and second embodiments, the HMDs 310 and 330 are equipped with the CG generation sections 315 and 335, respectively, and hence the users can view the virtual video using the HMD 310 and 330 alone, respectively (without requiring the virtual video generation apparatus 320).

The HMD 310 and the HMD 330 have the same configuration, and hence the components of the HMD 310 will be described, and description of the HMD 330 is omitted.

The sensor section 311, the video correction section 316, and the display section 317 are the same as the sensor section 111, the video correction section 112, and the display section 113 of the HMD 110 in the first embodiment, and hence description thereof is omitted.

The pre-processing section 312 acquires sensor signals output from the sensor section 311, performs processing for smoothing the acquired sensor signals so as to facilitate processing performed by the position-posture calculation section 313 at a downstream location, and further, can calculate depth information which can be used by the position-posture calculation section 313. Note that it is premised that the sensor section 311 is configured to be capable of detecting a physical amount for acquiring the depth information.

The position-posture calculation section 313 is the same as the position-posture calculation section 122 included in the virtual video generation apparatus 120 in the first embodiment. In the HMD 310, the position-posture calculation section 313 performs processing simpler (smaller in load) than the processing performed by the position-posture calculation section 122 of the virtual video generation apparatus 120 due to relationship between the calculation resources and power consumption. The sensor section 311, the pre-processing section 312, and the position-posture calculation section 313 form a detecting unit for detecting a position and/or a posture of the HMD 310.

The control communication section 314 is a semiconductor integrated circuit formed e.g. by a CPU, a ROM storing a program executed by the CPU, and a RAM having a program loading area and an area for temporarily storing data. The control communication section 314 performs centralized control of the operations of the components of the HMD 310 by loading programs stored in the ROM into the RAM to thereby control the overall operation of the HMD 310. Further, the control communication section 114 performs communication with external apparatuses including the virtual video generation apparatus 320, which are connected to the network 130, according to a predetermined protocol. For example, the control communication section 314 transmits a result of calculation performed by the position-posture calculation section 313 to the virtual video generation apparatus 320. On the other hand, the processing for calculating the depth information performed by the position-posture calculation section 313 tends to increase the load, and hence there is a possibility that a situation where the power consumption in the HMD 310 increases is produced. To prevent this, the control communication section 314 can also transmit the output from the sensor section 311 to an external apparatus as the sensor data, by bypassing the pre-processing section 312 and the position-posture calculation section 313.

The CG generation section 315 generates a CG video based on a result of the calculation performed by the position-posture calculation section 313. Generation of the CG video is not limited to this but can be performed by using a result of position-posture calculation, which is obtained from the virtual video generation apparatus 320, via the control communication section 314. In the present embodiment, the CG generation section 315 generates a CG video which is lower in resolution and/or frame rate and is smaller in bit number than the CG video generated by the virtual video generation apparatus 120 due to a relationship between the calculation resources and power consumption.

The virtual video generation apparatus 320 generates a virtual video (CG video) to be viewed by the users of the HMDs 310 and 330. The virtual video generation apparatus 320 includes a control communication section 321, a pre-processing section 322, a position-posture calculation section 323, a CG generation section 324, and a video correction section 325.

The control communication section 321, the position-posture calculation section 323, and the CG generation section 324 are the same as the control communication section 121, the position-posture calculation section 122, and the CG generation section 123 of the virtual video generation section 120 in the first embodiment, and hence description thereof in the present embodiment is omitted.

The pre-processing section 322 executes the same processing as that executed by the pre-processing section 312 of the HMD 310, but the calculation resources are more than those of the pre-processing section 312 and electric power required to execute complicated calculation is secured. Therefore, the pre-processing section 322 is enabled to execute more complicated processing and higher-level processing using the latest algorithm. Similarly, the video correction section 325 executes the same processing as that executed by the video correction section 316 of the HMD 310, but is enabled to execute more complicated processing and higher-level processing using the latest algorithm than that executed by the video correction section 316 due to relationship between the calculation resources and so forth. Note that the position-posture calculation section 323 and the CG generation section 324 are also enabled to execute more complicated processing and higher-level processing than those executed by the position-posture calculation section 313 and the CG generation section 315 of the HMD 310 due to relationship between the calculation resources and so forth.

The HMDs 310 and 330 and the virtual video generation section 320 each transmit the metadata 150 as information based on the operating state (such as a start-up state, a steady state, an interrupted state, and a temporarily incapable state) of each processing section and communication state of each transmission path in a state attached to a variety of data items.

Next, a description will be given of examples of the operation in the display communication system 300. As a first example, a case where the operation of the sensor section 311 of the HMD 310 is interrupted by some trouble will be described. In this case, the control communication section 314 generates the metadata 150 as information reporting the interruption of the sensor section 311 and transmits the metadata 150 to the virtual video generation apparatus 320 in a state attached to a variety of data items transmitted to the virtual video generation apparatus 320. After that, the control communication section 314 restarts the sensor section 301 and tries improvement of the trouble by setting the status of the sensor section 301 to the start-up state.

The virtual video generation apparatus 320 executes the same processing as that executed by the virtual video generation apparatus 120 in the second embodiment, based on the metadata 150 as the information reporting the interruption of the sensor section 311, whereby the user of the HMD 330 can recognize that a trouble has occurred in the HMD 310. Further, the control communication section 334 of the HMD 330 causes the CG generation section 335 to generate a CG video based on the position and/or the posture of the HMD 330, which are/is estimated by the position-posture calculation section 333, in place of the CG video acquired from the virtual video generation apparatus 320, and displays the generated CG video on the display section 337.

Note that in the virtual video generation apparatus 320, the control communication section 321 can interrupt the processing operations of the respective components after acquisition of the metadata 150, and this makes it possible to reduce consumption of the resources. In this case, upon receipt of the metadata 150 as information reporting completion of recovery of the sensor section 301, the control communication section 321 immediately instructs the components to restart the processing operations.

As a second example, a case where the processing sections and the transmission lines are in the stable steady state in the display communication system 300 will be described. In this case, the pre-processing sections 312 and 332, the position-posture calculation sections 313 and 333, the CG generation sections 315 and 335, and the video correction sections 316 and 336 of the HMDs 310 and 330 are not required to be used. Then, by displaying the CG video transmitted from the virtual video generation apparatus 320 on the display sections 317 and 337, it is possible to display the high-quality CG video on the display sections 317 and 337 while reducing the power consumptions of the HMDs 310 and 330. However, this is not limitative, part of the pre-processing sections 312 and 332, the position-posture calculation sections 313 and 333, the CG generation sections 315 and 335, and the video correction sections 316 and 336 of the HMDs 310 and 330 can be operated.

As a third example, a case will be described where execution of calculation processing for an external apparatus, not shown, is required in the virtual video generation apparatus 320, in a situation where the display communication system 300 is in the steady state and, at the same time, the CG generation section 324 of the virtual video generation apparatus 320 is generating the CG video. In this case, the calculation load on the virtual video generation apparatus 320 is increased, which can cause some trouble, such as extreme reduction in the amount of processing executed by the CG generation section 324, causing delay of the CG video. Then, the control communication section 321 of the virtual video generation apparatus 320 generates the metadata 150 as information on the delay caused in the CG generation section 324 and transmits the generated metadata 150 to the HMDs 310 and 330 in a state attached to the data to be transmitted to the HMDs 310 and 330.

Upon receipt of the data to which the metadata including the delay information is attached, the control communication sections 314 and 334 of the HMDs 310 and 330 instruct each of the CG generation sections 315 and 335 to generate the CG video. That is, the control communication sections 314 and 334 switch the processing path for receiving the CG video from the virtual video generation apparatus 320 and displaying the received CG video to a processing path for generating the CG video within each self-device of the HMDs 310 and 330 and displaying the generated CG video. With this, the users of the HMDs 310 and 330 can continue viewing of the video without interruption of the video and without feeling strangeness caused by a large delay, even if the quality of the CG video is lowered.

Next, an example of the information of the metadata 150 and an example of the operation using this will be described.

As the information of the metadata 150, there can be mentioned, for example, information concerning the communication state and signal loss of each transmission path connecting between the processing sections in each of the HMDs 310 and 330 and the virtual video generation apparatus 320, and information concerning the communication state of the network 130. The display communication system formed by a plurality of HMDs and a plurality of virtual video generation apparatuses has a plurality of transmission paths between the plurality of apparatuses and the transmission paths within each apparatus, and hence information at a location where a trouble has occurred is important information for analyzing the cause and restoring or temporarily continuing the operation, and further for stabilizing the system.

For example, there is a case where a trouble (communication trouble), such as a jam, occurs in the communication state between the HMDs 310 and 330 and the network 130 or communication between the network 130 and the virtual video generation apparatus 320. Note that the control communication sections 314 and 334 of the HMDs 310 and 330 and the control communication section 321 of the virtual video generation apparatus 320 can grasp the communication state of the network 130 from the data exchanged according to a predetermined protocol. In a case where a communication trouble has occurred, the control communication sections 314 and 334 of the HMDs 310 and 330 each cause the self-device to separate from the network 130 and operate in a stand-alone mode. With this, the users of the HMDs 310 and 330 can continue viewing of the CG video although lowering of the image quality cannot be prevented.

Further, there are a case where data loss occurs in the data (signal) transmitted from a processing section at an upstream location to a processing section at a downstream location or a trouble occurs in a transmission path between the processing sections, and a case where a trouble occurs in each processing section. These troubles can be determined by a processing section that receives the data (signal), and the processing section having detected the trouble notifies the control communication section of the self-apparatus of occurrence of the trouble.

An example of a step for detecting a processing section or transmission path where a trouble has occurred will be described. Let it be assumed that, in the virtual video generation apparatus 320, the position-posture calculation section 323 receives data in which data loss has occurred from the pre-processing section 322. In this case, the control communication section 321 checks the transmission path from the pre-processing section 322 to the position-posture calculation section 323, and if there is no problem, the control communication section 321 checks the operation of the pre-processing section 322. Then, if there is no problem in the pre-processing section 322, the control communication section 321 further checks the transmission path from the control communication section 321 to the pre-processing section 322. Thus, the control communication section 321 further sequentially checks a transmission path and a processing section at each upstream location. In a case where a location where the trouble has occurred can be identified, the control communication section 321 eliminates the trouble e.g. by resetting the location where the trouble has occurred or switching the processing section to a processing section having an equivalent function.

Further, if a trouble has occurred in the position-posture calculation sections 313 and 343 of the HMDs 310 and 330, the processing in the position-posture calculation sections 313 and 343 is switched to the processing in the position-posture calculation section 323 of the virtual video generation apparatus 320. If a trouble has occurred in the video correction section 325 of the virtual video generation apparatus 320, the processing is switched to the processing in the video correction sections 316 and 336 of the HMDs 310 and 330. This makes it possible to suppress an influence on the users of the HMDs 310 and 330 and continue provision of the CG video.

Note that in a case where connection with the virtual video generation apparatus 320 is disconnected due to a trouble having occurred in the virtual video generation apparatus 320, the HMDs 310 and 330 can change the connection destination to another virtual video generation apparatus. Further, in a case where a trouble has occurred in the network being connected, whereby communication with the virtual video generation apparatus 320 is discontinued, the HMDs 310 and 330 can connect to the virtual video generation apparatus 320 via another network. For example, connection can be switched between Wi-Fi (registered trademark) and a moving communication system (4G and 5G).

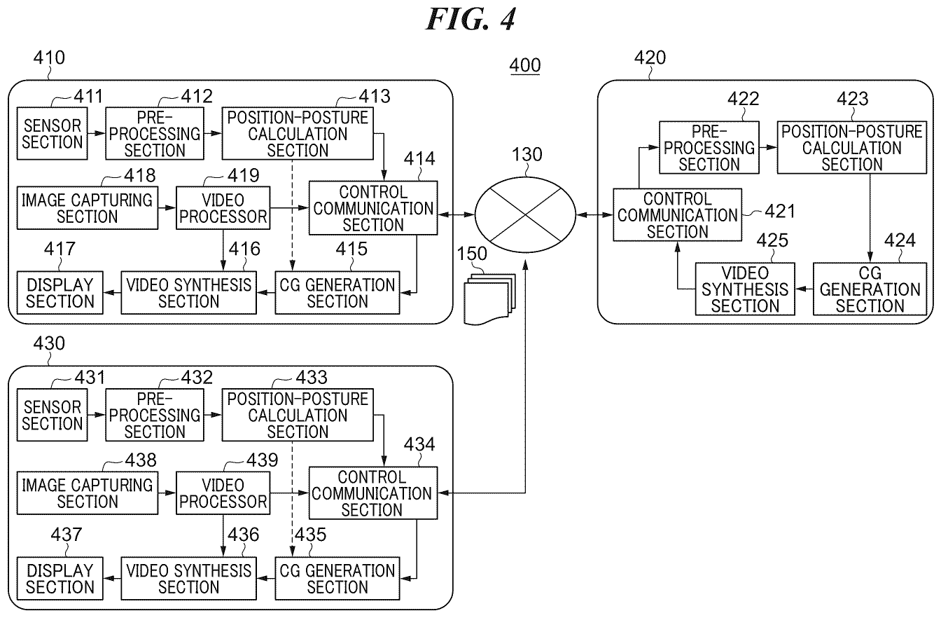

FIG. 4 is a diagram showing a schematic configuration of a display communication system 400 according to a fourth embodiment. The display communication system 400 is formed by communicably connecting HMDs 410 and 430 and a virtual video generation apparatus 420 via the network 130. The network 130 and the metadata 150 are the same as those described in the first embodiment, and hence description thereof is omitted.

The HMD 410 includes a sensor section 411, a pre-processing section 412, a position-posture calculation section 413, a control communication section 414, a CG generation section 415, a video synthesis section 416, a display section 417, an image capturing section 418, and a video processor 419. Similarly, the HMD 430 includes a sensor section 431, a pre-processing section 432, a position-posture calculation section 433, a control communication section 434, a CG generation section 435, a video synthesis section 436, a display section 437, an image capturing section 438, and a video processor 439.

The HMD 410 and the HMD 430 have the same configuration, and hence the components of the HMD 410 will be described, and description of the HMD 430 is omitted.

The HMD 410 is configured by adding the image capturing section 418 and the video processor 419 to the HMD 310 in the third embodiment and changing the video correction section 316 to the video synthesis section 416, and except these components, is configured similar to the HMD 310. Therefore, description of the sensor section 411, the pre-processing section 412, the position-posture calculation section 413, the control communication section 414, the CG generation section 415, and the display section 417, included in the HMD 410, is omitted.

The image capturing section 418 acquires a real video of the outside world observed by the user of the HMD 410. The image capturing section 418 is often formed by combining an objective optical system and an image sensor, and it is desirable that the image capturing section 418 communicates with a color video and supports acquiring a video of an angle of view which is wider than an angle of view of the display section 417. In a case where the image sensor included in the image capturing section 418 supports the color video, Bayer interpolation from raw data is generally required, and hence development processing from the raw data is required. In view of this, the video processor 419 performs processing for developing a real video acquired by the image capturing section 418 and a variety of correction processing operations. Further, the video processor 419 performs shading correction for correcting the luminance, color correction, noise reduction, distortion correction, view angle correction as that for a stereo camera, and so forth, to improve the image quality of the video, as required.

The video synthesis section 416 has not only the function of the video correction section 316 included in the HMD 310 in the third embodiment, but also a function of acquiring a real video from the video processor 419 and synthesizing the acquired real video with the CG video. The CG video can be acquired from the virtual video generation apparatus 420 or can be generated by the CG generation section 415.

The video obtained by superimposing the real video and the virtual video makes it possible to realize expression close to expression of the video see-through-type MR. On the other hand, in a case where the display section 417 is translucent and the real video is not superimposed on the virtual video, it is possible to realize expression close to expression of the optical see-through-type AR. Note that when only a CG video is displayed in a case where the display section 417 is opaque, expression of VR is obtained.

The virtual video generation apparatus 420 includes a control communication section 421, a pre-processing section 422, a position-posture calculation section 423, a CG generation section 424, and a video synthesis section 425. The control communication section 421, the pre-processing section 422, the position-posture calculation section 423, and the CG generation section 424 are the same as the control communication section 321, the pre-processing section 322, the position-posture calculation section 323, and the CG generation section 324 of the virtual video generation apparatus 320 in the third embodiment, and hence description thereof is omitted. The video synthesis section 425 extends the function and processing by using a real video acquired from the HMDs 410 and 430. For example, the video synthesis section 425 performs three-dimensional reconstruction processing for converting a real video to a CG video.

In the display communication system 400 as well, the same metadata as the metadata 150 described in the third embodiment is also attached to a variety of data items to be transmitted and received. In the display communication system 400, further, information concerning a CG projection error based on results of determination performed by the respective processing sections of the HMDs 410 and 430 and the virtual video generation apparatus 420 is attached to the variety of data items as the metadata 150. Note that the CG projection error refers to a displacement between a position where the CG video is to be originally displayed and a position where the CG video is actually displayed.

For example, let it be assumed that, based on video signals acquired by the image capturing section 418 and the output from the sensor section 411 of the HMD 410, the position-posture calculation section 413 estimates a position and/or a posture of the user of the HMD 410 by extracting feature points in a space, generating a map of the space and performing collation with the space map. Further, let it be assumed that a position and/or a posture of the user of the HMD 430 are similarly estimated.

At this time, for example, let it be assumed that a trouble has occurred in the output signal from the sensor section 411 or the processing of the sensor data, causing loss or unclearness in part of the space map commonly used by the HMDs 410 and 430. Then, a position and/or a posture estimated by collation with the space map become(s) different from the actual position and/or posture of the HMD 410, and the CG video to be rendered becomes different from the one viewed from the actual place of the HMD 410. The CG projection error caused as described above becomes a cause inhibiting the high-quality MR experience.

To cope with this situation, in the display communication system 400, the position-posture calculation section 423 of the virtual video generation apparatus 420 determines whether or not the CG projection error has an abnormality. Therefore, the control communication section 421 of the virtual video generation apparatus 420 generates metadata indicating the abnormality in the CG projection error caused due to the output from the sensor section 411 of the HMD 410 and transmits the generated metadata to the HMDs 410 and 430 in a state attached to the data to be transmitted to the HMDs 410 and 430. Note that the position-posture calculation sections 413 and 433 of the HMDs 410 and 430 each can determine whether or not the CG projection error has an abnormality in the self-device. Then, the control communication section 434 of the HMD 430 switches the processing path for displaying a CG video acquired from the virtual video generation apparatus 420 to the processing path for causing the CG generation section 435 to generate a CG video based on a result of processing performed by the position-posture calculation section 433 and displaying the generated CG video on the display section 437. Note that in a case where metadata indicating that the CG projection error has been eliminated from the virtual video generation apparatus 420, the control communication section 434 switches the processing path back to the processing path for displaying a CG video acquired from the virtual video generation apparatus 420 on the display section 437.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-134707 filed Aug. 22, 2023, which is hereby incorporated by reference herein in its entirety.

What is claimed is:

1. A display device comprising:
a communication unit configured to perform communication with an external apparatus;
a display unit configured to display an image;
at least one processor; and
a memory coupled to the at least one processor storing instructions that, when executed by the processor, cause the processor to function as:
an acquisition unit configured to acquire image data of an image to be displayed on the display unit, from the external apparatus via the communication unit;
a correction unit configured to correct the image to be displayed on the display unit; and
a control unit configured to generate first metadata of information concerning an operating state and a communication state of the display device and attach the generated first metadata to data to be transmitted to the external apparatus.

2. The display device according to claim 1, wherein the first metadata includes information concerning a trouble having occurred in a processing section as a component of the display device and a trouble having occurred in a communication path in the display device, and
wherein the control unit tries improvement of the trouble.

3. The display device according to claim 1, further comprising an image capturing unit, and
wherein the processor also functions as a processing unit configured to perform predetermined processing on an image acquired by the image capturing,
wherein the correction unit performs processing for synthesizing an image acquired from the external apparatus and an image output from the processing unit, and
wherein the control unit displays an image synthesized by the correction unit on the display unit.

4. The display device according to claim 1, wherein in a case where second metadata included in a data file acquired from the external apparatus via the communication unit includes information concerning occurrence of a trouble in the external apparatus, the control unit controls the correction unit to execute correction responsive to the trouble on the image of the image data acquired by the acquisition unit.

5. The display device according to claim 1, wherein the processor also functions as an estimation unit configured to estimate a position and/or a posture of the display device, and
a generation unit configured to generate the image to be displayed on the display unit, based on a result of estimation performed by the estimation unit, and
wherein in a case where second metadata included in a data file acquired from the external apparatus via the communication unit includes information concerning occurrence of a trouble in the external apparatus, and a case where the second metadata includes an abnormality of a projection error in the display device, the control unit performs control to display an image generated by the generation unit on the display unit in place of the image of the image data acquired by the acquisition unit.

6. The display device according to claim 5, further comprising an image capturing unit, and
wherein the processor also functions as a processing unit configured to perform predetermined processing on an image acquired by the image capturing unit, and
wherein the correction unit performs processing for synthesizing an image generated by the generation unit and an image output from the processing unit, and
wherein the control unit displays an image synthesized by the correction unit on the display unit.

7. The display device according to claim 1, wherein in a case where second metadata included in a data file acquired from the external apparatus via the communication unit includes information concerning occurrence of a trouble in the external apparatus, the control unit controls the communication unit to switch communication from the external apparatus to another external apparatus and acquires the image to be displayed on the display unit from the other external apparatus.

8. The display device according to claim 1, wherein the control unit generates third metadata concerning a condition of communication with the external apparatus and attaches the generated third metadata to data to be transmitted to the external apparatus.

9. An information processing apparatus that performs communication with a display device, comprising:
at least one processor; and
a memory coupled to the at least one processor storing instructions that, when executed by the processor, cause the processor to function as:
a reception unit configured to receive information for estimating a position and/or a posture of the display device;
an estimation unit configured to estimate the position and/or the posture of the display device based on the information;
a generation unit configured to generate an image to be displayed on a display unit included in the display device, based on the position and/or the posture of the display device, which are/is estimated by the estimation unit;
a transmission unit configured to transmit image data of an image generated by the generation unit to the display device; and
a control unit configured to generate metadata of information concerning an operating state and a communication state of the information processing apparatus and attach the generated metadata to data to be transmitted to the display device.

10. The information processing apparatus according to claim 9, wherein the metadata includes information concerning a trouble having occurred in a processing section as a component of the information processing apparatus and a trouble having occurred in a communication path in the information processing apparatus.

11. The information processing apparatus according to claim 10, wherein the metadata includes delay information in a case where the processing in the estimation unit or the generation unit is delayed.

12. The information processing apparatus according to claim 9, wherein the estimation unit determines whether or not a projection error in the display device has an abnormality, based on the information for estimating the position and/or the posture of the display device, and
wherein in a case where it is determined that the projection error has an abnormality, the control unit causes information concerning the abnormality of the projection error to be included in the metadata.

13. An information processing system including a display device and an information processing apparatus,
wherein the display device comprises:
a first communication unit configured to perform communication with the information processing apparatus;
a display unit configured to display an image;
at least one processor; and
a memory coupled to the at least one processor storing instructions that, when executed by the processor, cause the processor to function as:
a detection unit configured to detect information for estimating a position and/or a posture of the display device;
an acquisition unit configured to acquire an image to be displayed on the display unit from the information processing apparatus;
a first correction unit configured to correct the image to be displayed on the display unit; and
a first control unit configured to generate first metadata of information concerning an operating state and a communication state of the display device and attach the generated first metadata to data to be transmitted to the information processing apparatus, and
wherein the information processing apparatus comprises:
a second communication unit configured to perform communication with the display device;
at least one processor; and
a memory coupled to the at least one processor storing instructions that, when executed by the processor, cause the processor to function as:
a first estimation unit configured to estimate a position and/or a posture of the display device based on the information acquired from the display device via the second communication unit;
a first generation unit configured to generate an image to be displayed on the display unit based on the position and/or the posture of the display device, estimated by the first estimation unit;
a transmission unit configured to transmit an image generated by the first generation unit to the display device; and
a second control unit configured to generate second metadata of information concerning an operating state and a communication state of the information processing apparatus and attach the generated second metadata to data to be transmitted to the display device.

14. The information processing system according to claim 13, wherein the processor of the display device is also caused to function as:
a second estimation unit configured to estimate the position and/or the posture of the display device based on the information detected by the detection unit; and
a second generation unit configured to generate the image to be displayed on the display unit, based on a result of estimation performed by the second estimation unit, and
wherein in a case where the second metadata includes information concerning occurrence of a trouble in the information processing apparatus, the first control unit performs control to cause the second generation unit to generate the image to be displayed on the display unit and display the image generated by the second generation unit on the display unit in place of the image acquired by the acquisition unit.

15. The information processing system according to claim 13, wherein in a case where the second metadata includes information concerning occurrence of a trouble in the information processing apparatus, the first control unit controls the first correction unit such that the information concerning the trouble is displayed on the image displayed on the display unit.

16. The information processing system according to claim 13, wherein the processor of the information processing apparatus is also caused to function as a second correction unit configured to correct the image generated by the first generation unit, and
wherein in a case where the first metadata includes information concerning occurrence of a trouble in the display device, the second control unit controls the second correction unit such that information concerning the trouble is displayed on the image generated by the first generation unit.

17. A method of controlling a display device that performs communication with an external apparatus, comprising:
acquiring image data of an image to be displayed on a display unit included in the display device from the external apparatus by communication;
displaying an image acquired from the external apparatus on the display unit; and
generating metadata of information concerning an operating state and a communication state of the display device and attaching the generated metadata to data to be transmitted to the external apparatus.

18. A method of controlling an information processing apparatus that performs communication with a display device, comprising:
receiving information for estimating a position and/or a posture of the display device;
estimating the position and/or the posture of the display device based on the information;
generating an image to be displayed on a display unit included in the display device, based on the estimated position and/or posture of the display device; and
generating metadata of information concerning an operating state and a communication state of the information processing apparatus and transmitting the generated metadata to the display device in a state attached to data to be transmitted to the display device.

19. A non-transitory computer-readable storage medium storing a program for causing a computer to execute a method of controlling a display device that performs communication with an external apparatus,
wherein the method comprises:
acquiring image data of an image to be displayed on a display unit included in the display device from the external apparatus by communication;
displaying an image acquired from the external apparatus on the display unit; and
generating metadata of information concerning an operating state and a communication state of the display device and attaching the generated metadata to data to be transmitted to the external apparatus.

20. A non-transitory computer-readable storage medium storing a program for causing a computer to execute a method of controlling an information processing apparatus that performs communication with a display device,
wherein the method comprises:
receiving information for estimating a position and/or a posture of the display device;
estimating the position and/or the posture of the display device based on the information;
generating an image to be displayed on a display unit included in the display device, based on the estimated position and/or posture of the display device; and
generating metadata of information concerning an operating state and a communication state of the information processing apparatus and transmitting the generated metadata to the display device in a state attached to data to be transmitted to the display device.
